(19) United States
(12) Patent Application Publication
(10) Pub. No.: US 2006/0208467 A1
(43) Pub. Date: Sep. 21, 2006

(54) Head impact energy-absorbing inflatable curtain gas delivery tube

(75) Inventor: Michel G. Khouri, Birmingham, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/165,331

(22) Filed: Jun. 24, 2005

Related U.S. Application Data
(60) Provisional application No. 60/662,932, filed on Mar. 18, 2005.

(51) Int. Cl. B60R 21/213; B60R 21/26

(52) U.S. Cl. 280/730.2; 280/740

(57) ABSTRACT

An inflatable curtain gas delivery tube that provides energy absorption and a curtain system that uses the gas delivery tube. The energy-absorbing inflatable curtain gas delivery tube may include an inner tube and an outer tube. The inner tube may be positioned within the outer tube so that the outer tube may provide structural support to the inner tube. The inner tube and outer tube may be composed of materials and structures to provide an energy-absorbing design for reducing the force that a vehicle occupant is subjected to during a head impact to the gas delivery tube.

### BACKGROUND

The present invention relates to an inflatable curtain gas delivery tube that provides energy absorption and a curtain system that uses the gas delivery tube.

In a conventional inflatable curtain gas delivery tube, steel tubing is used to deliver gas to the side curtain of a vehicle. Steel tubing is often expensive and additional, localized energy absorbing components made of steel or plastic are used to protect vehicle occupants, particularly from head impacts to the gas delivery tube.

### SUMMARY

It is an object of the present invention to provide an energy-absorbing inflatable curtain gas delivery tube for reducing the force that a vehicle occupant may be subject to from a head impact with the gas delivery tube. It is an object of the present invention to provide head impact energy-absorption in a uniform and repeatable fashion.

It is a further object of the present invention to provide an energy-absorbing gas delivery tube that is economical and efficient in design and that does not resort to specialized and localized energy-absorbing components.

An energy-absorbing inflatable curtain gas delivery tube, according to an embodiment of the present invention, includes an inner tube and an outer tube. The inner tube is positioned within the outer tube so that the outer tube may provide structural support to the inner tube. The inner tube and outer tube may be composed of materials and structures to provide an energy-absorbing design for reducing the force that a vehicle occupant may be subjected to from a head impact with the gas delivery tube. In particular, the tubes may be designed to help reduce the force that a vehicle occupant is subjected to from a head impact to the gas delivery tube, such as a FMVSS-201 type head form hit.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view of an energy-absorbing gas delivery tube according to an embodiment of the present invention.

FIG. 2 is a side view of an energy-absorbing gas delivery tube according to an embodiment of the present invention.

FIG. 3 is an end view of the outer tube of the energy-absorbing gas delivery tube according to an embodiment of the present invention.

FIG. 4 is a side view of an inflatable side curtain system with a curved tube mounted in a vehicle before deployment according to an embodiment of the present invention.

FIG. 5 is a side view of an inflatable side curtain system with a curved tube mounted in a vehicle after deployment according to an embodiment of the present invention.

FIG. 6 is a side view of an inflatable side curtain system with a linear tube mounted in a vehicle before deployment according to an embodiment of the present invention.

FIG. 7 is a cross-section side view of an inflator according to an exemplary embodiment of the present invention.

FIG. 8 is a cross-sectional view of a portion of a tube according to an embodiment of the present invention.

FIG. 9 is a cross-sectional view of a portion of a tube according to another embodiment of the present invention.

FIG. 10 is a cross-sectional side view of a tube according to an exemplary embodiment of the present invention.

### DETAILED DESCRIPTION

Embodiments of the present invention will be described below with reference to the drawings.

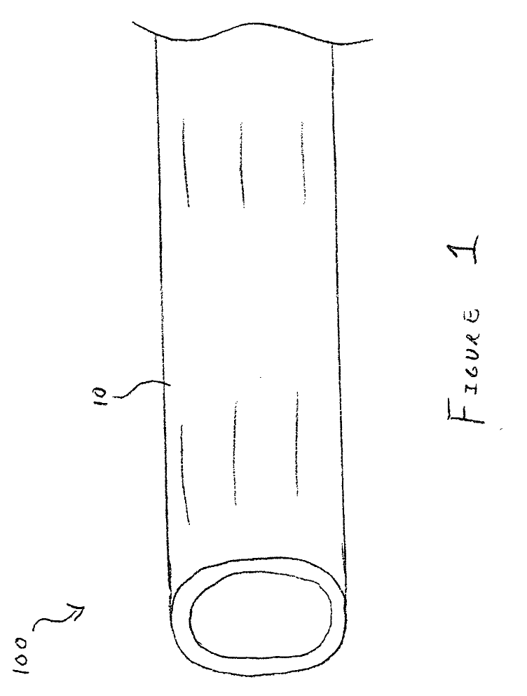

FIG. 1 shows a side view of an energy-absorbing gas delivery tube 100 according to an embodiment of the present invention. The gas delivery tube 100 may include a tube 10 that is composed of an energy-absorbing material.

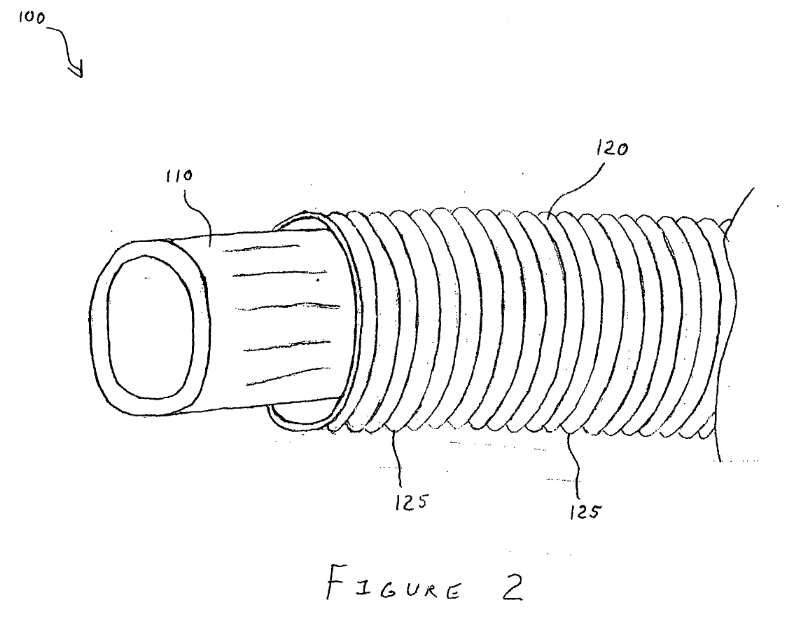

FIG. 2 shows a side view of an energy-absorbing gas delivery tube 100 according to an embodiment of the present invention. The gas delivery tube 100 may include an inner tube 110 that is enclosed by outer tube 120. The inner tube 100 may be composed of a plastic material. For example, the inner tube may be composed of a thermoplastic that has been extruded into the form of a tube. The inner tube 100 may be flexible and may be designed to enhance the energy-absorbing properties of the gas delivery tube.

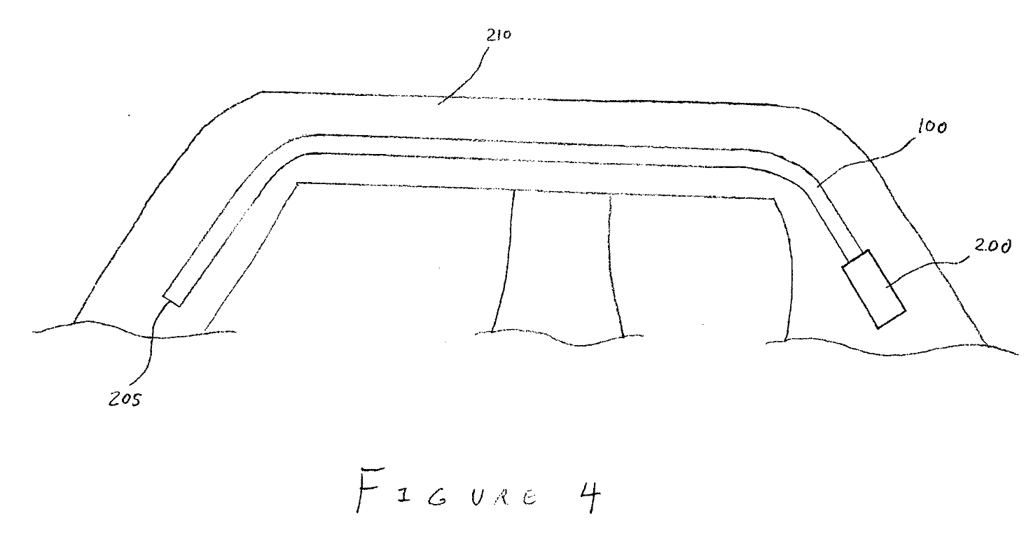

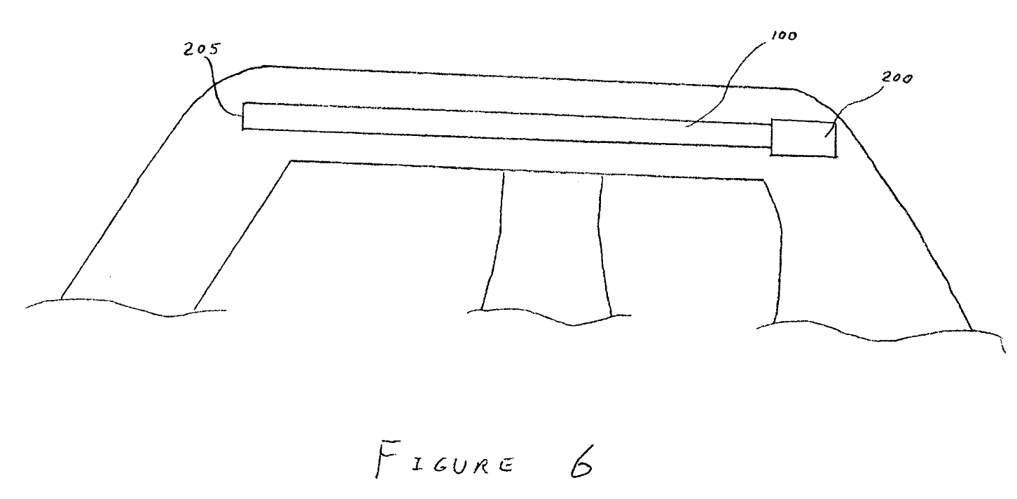

Gas delivery tube 100 may have a length that extends along the side of a vehicle, as shown in FIGS. 4 and 6. The gas delivery tube 100 may be curved, as in the example shown in FIG. 4, or the gas delivery tube 100 may be linear, as in the example shown in FIG. 6. Gas delivery tube may have a termination 205 at one end and may be connected to an inflator 200 at its other end. Inflator 200 provides inflation gas that flows through gas delivery tube 100 and to a side curtain. Gas delivery tube 100 may have holes along its length for delivery of gas to respective airbag cushions along the length of the curtain. The outer tube 120 encloses the inner tube 10 to provide structural support to the inner tube 10 so that the inner tube 110 does not rupture during gas delivery. Therefore, the outer tube 120 acts as a support shell for the inner tube 110, allowing it to withstand the shock loading pressures that occur during deployment of the curtain. The outer tube 120 may be composed of an energy-absorbing material. For example, the outer tube may be composed of aluminum.

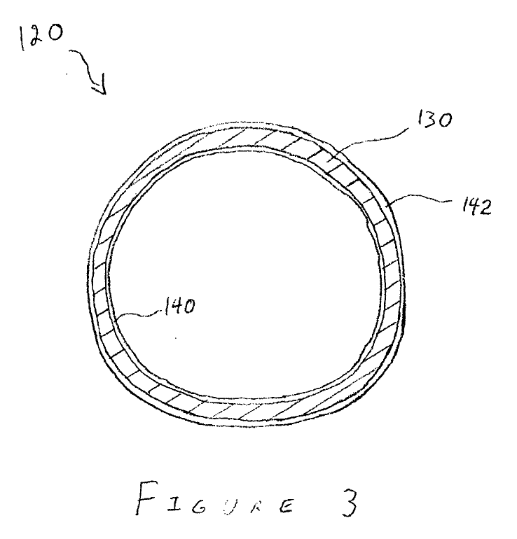

FIG. 3 shows an end view of an outer tube 120 according to an embodiment of the present invention. In this embodiment, the outer tube 120 is composed of a coil 130 that is enclosed in an inner layer 140 and an outer layer 142. For example, the outer tube 120 may be composed of an aluminum coil or spring-like tube that is sheathed in an inner layer of paper and an outer layer of paper. Such a tube would be structured so that the surface of the tube has corrugations 125, as shown in FIG. 2. Such a structure may provide an energy-absorbing design and may provide a flexible gas delivery tube that may be bent and/or rolled into a loop, allowing the tube to be packaged in a smaller design. The outer tube 120 may also be a smooth tube or a solid tube with corrugations on its surface. The outer tube 120 may use other energy-absorbing structures, such as honeycomb structures, truss structures, and other energy-absorbing structures known in the art.

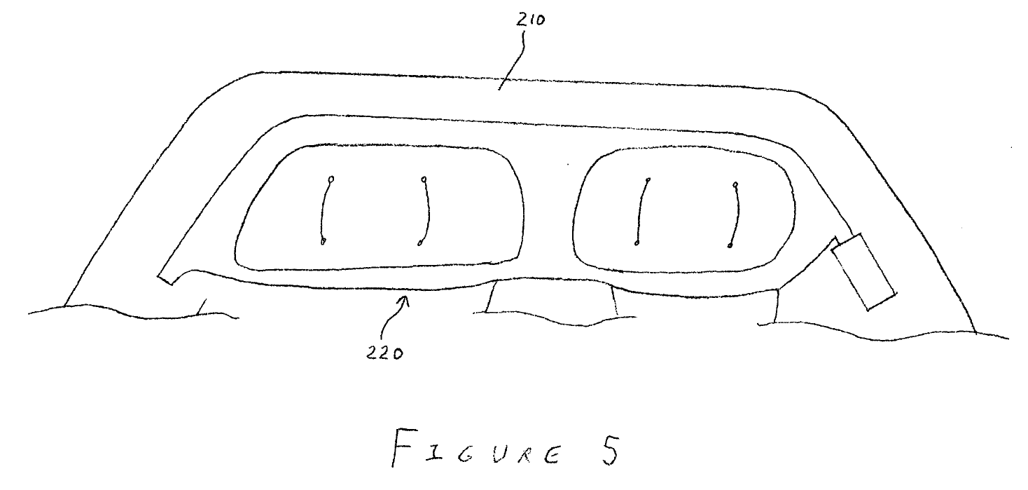

FIG. 4 shows a curtain system in which a gas delivery tube 100 has been installed in a vehicle to reduce the force that a vehicle occupant is subjected to, particularly from head impacts to the gas delivery tube 100. In the example shown in FIG. 4, the gas delivery tube 100 has been installed in the headliner 210 of the vehicle. FIG. 5 shows a curtain system after deployment, so that a curtain 220 has been deployed along the side of a vehicle. An example of a curtain is shown in FIG. 5 but other curtain designs may be used with the curtain system and gas delivery tube, as is known in the art.

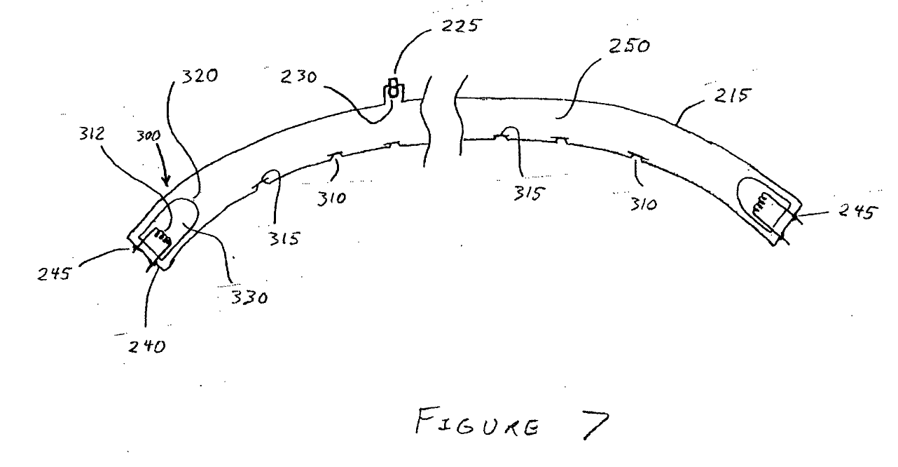

According to an embodiment of the present invention an inflator is provided. As shown in FIG. 7, the inflator includes a tube 215 having a plurality of openings 310. The tube 215 may be composed of an energy-absorbing material and the tube 215 may include a single tube, as shown in the example of FIG. 1, or the tube may include an inner tube and an outer tube, as shown in the example of FIG. 2.

The tube 215 includes an interior chamber 250 that is filled with an inert gas. The inert gas may include, for example, Argon or Helium. The inert gas may be charged into the tube 215 through gas inlet opening 225. After the gas is charged into the tube, the inlet 225 may be sealed, for example, by a ball weld 230. Thus, prior to initiation, the inflator is filled with a prepressurized gas.

The tube 215 includes two ends 240. Each end 240 of the tube contains an inflation device 300. The inflation device 300 includes an igniter or initiator 312 and a booster cap 320. The cap 320 covers the igniter 312 and contains a booster propellant 330. Each end 240 of the tube is sealed by caulking material 245. The igniter 312 includes a portion that extends out of the tube 215 and is operatively connected to a control circuit that sends a trigger signal to the igniter when a collision involving the related vehicle is determined to be imminent.

Prior to initiation of the inflator, each of the openings 310 is sealed. According to one exemplary embodiment of the present invention, the openings 310 are closed by a seal 315. The seal 315 is configured to rupture or break when the pressure of the inert gas reaches a predetermined level. The seal 315 may include tape or other similar membranes. If the tube 215 includes an inner tube and an outer tube, such as in the example shown in FIG. 2, the openings 310 may be formed in the inner tube, the outer tube, or both the inner tube and outer tube.

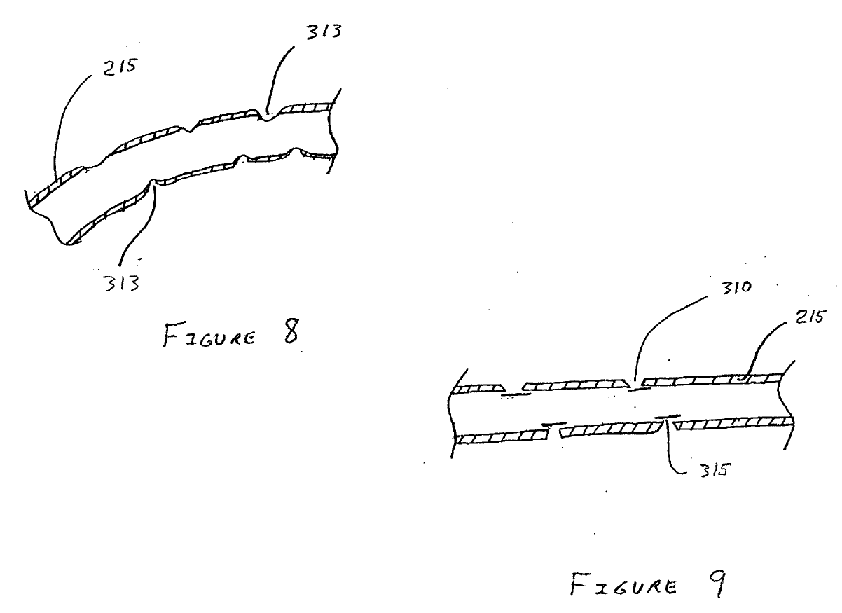

Alternatively, as shown in FIG. 8, the opening 310 may be formed as a partial puncture 313 of the wall of the tube 215. For example, the tube 215 may be formed of stainless material and a punch may be used to partially penetrate the wall of the tube 215 to create a weakened portion that ruptures when the pressure of the inert gas located in the tube reaches a predetermined level.

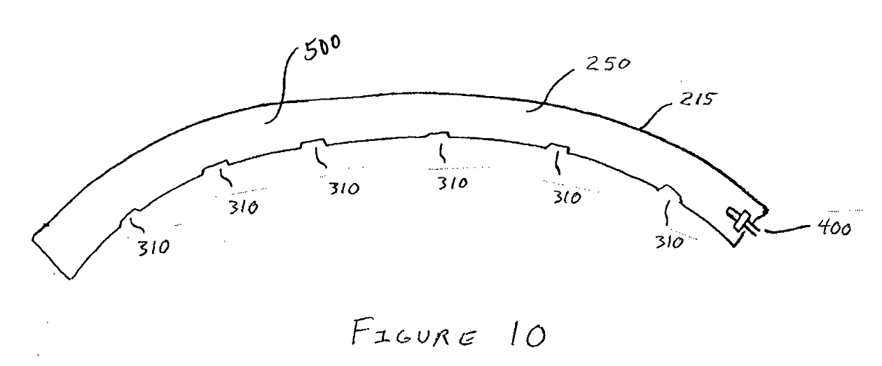

As mentioned above, the tube 215 may be formed of stainless steel or other material of sufficient strength to contain the pressurized gas. According to a preferred embodiment of the present invention, the tube 215 may be bent to conform to the shape of the airbag containing the inflator. However if, for example, the airbag contains a substantially straight upper portion, the tube 215 may extend along an essentially straight line as shown in FIG. 9.

In operation, the initiator 312 is triggered by a signal generated by a sensor (e.g., an acceleration type crash sensor) in response to the sensor detecting that a collision involving the vehicle is imminent. After triggering of the initiator 312, the booster propellant 330 ignites creating exhaust gas that ruptures the cap 320 and raises the pressure of the inert gas contained within the tube 215. The pressure of the inert gas rises thereby causing the outflow openings 310 to become unsealed allowing gas to escape from the inflator into the airbag. As the gas exits the tube 215 and enters the airbag, the airbag deploys quickly and evenly along the side of the vehicle cab and covering the pillars of the vehicle.

The creation of a flow path through the openings 310 may occur, for example, due to the failure of a weakened portion 313 of the tube 215 (FIG. 8) or due to the failure of a seal member 315 (FIG. 9). The opening 310 is configured so that the gas pressure required to rupture the seal and create the opening 310 can be predetermined.

As shown in FIGS. 8 and 9, the gas outflow openings 310 may be positioned at various locations along the exterior of the tube 215. The positioning of the openings 310 in a variety of locations may allow some or all of the airbag to be inflated more quickly.

As is evident from the description above, the provision of an inflator along substantially the entire length of an airbag allows the airbag to be inflated quickly and evenly to thereby provide improved protection to the occupant of the vehicle.

The present invention also includes an embodiment of an inflator containing a gas generant or propellant as an alternative to the stored gas. According to yet another embodiment the inflator may contain a decomposing type material as the source of the pressurized gas for the airbag.

As shown in FIG. 10, according to another embodiment of the present invention the tube 215 may contain a gas generating material, such as, for example, a gas generant or propellant 500. The inflator may also contain a standard igniter 400 or initiator assembly disposed at one end of the tube 100. The igniter 400 receives a signal from a firing circuit or controller in order to initiate operation of the inflator.

The propellant charge or gas generant 500 may extend for all, most, or same of the length of the tube 215 thereby facilitating a substantially uniform gas generation once the propellant 500 is ignited. Substantially uniform gas generation across the length of the inflator is beneficial to achieve uniform inflation of an airbag. The plurality of gas outlets 310 fluidly communicate with the airbag once the propellant 500 is ignited and thereby provide sustained and uniform inflation over the length of the airbag. The propellant material may be selected from conventional known propellants such as disclosed in U.S. Patent Application Publication 2001/0045735 A1. A cascade type inflator may include a tube 215. In the cascade inflator, propellant or gas generation material may be distributed along the length of the tube. When inflation of the airbag is initiated, the inflation gas is produced at the point of initiation so that production of inflation gas cascades along the length of the tube. The tube may have one or several points of inflation gas initiation. The point of inflation gas initiation may be at an end of the tube or at any point along the length of the tube.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A gas delivery tube for a side curtain airbag, comprising: an energy-absorbing material, wherein the tube is adapted to deliver inflation gas to a side curtain airbag, wherein the side curtain airbag is configured to inflate along a side of a vehicle.

2. The gas delivery tube of claim 1, wherein the tube includes:
an inner tube; and
an outer tube composed of metal, wherein the inner tube is disposed within the outer tube so that the outer tube provides structural reinforcement for the inner tube.

3. The gas delivery tube of claim 2, wherein the inner tube comprises a plastic material.

4. The gas delivery tube of claim 2, wherein the outer tube comprises aluminum.

5. The gas delivery tube of claim 2, wherein the outer tube is a corrugated tube.

6. The gas delivery tube of claim 2, wherein the outer tube is a coil.

7. The gas delivery tube of claim 2, wherein the outer tube is sheathed between an inner layer of material and an outer layer of material.

8. An inflatable curtain system for a vehicle, comprising:
a gas generator;
an airbag; and
a tube for carrying gas from the gas generator to the airbag, wherein the tube comprises an energy-absorbing material.

9. The inflatable curtain system of claim 8, wherein the tube comprises an inner tube and an outer tube, and wherein the inner tube is disposed within the outer tube so that the outer tube provides structural reinforcement for the inner tube.

10. The inflatable curtain system of claim 9, wherein the inner tube comprises a plastic material.

11. The inflatable curtain system of claim 9, wherein the outer tube comprises a metal.

12. The inflatable curtain system of claim 11, wherein the outer tube comprises aluminum.

13. The inflatable curtain system of claim 8, wherein the outer tube is a corrugated tube.

14. The inflatable curtain system of claim 8, wherein the outer tube is a coil.

15. The inflatable curtain system of claim 8, wherein the outer tube is sheathed between an inner layer of material and an outer layer of material.

16. An airbag system for a vehicle comprising:
an airbag configured to inflate along an interior side of a vehicle; and
an inflator including a tube extending along a side of the vehicle;
wherein the tube comprises an energy-absorbing material.

17. An airbag system for a vehicle comprising:
an airbag configured to inflate along an interior side of a vehicle; and
an elongated inflator including a tube extending along a side of the vehicle and containing gas generating material along substantially the entire length of the tube;
wherein the tube comprises an energy absorbing material.
